(19) United States
(12) Patent Application Publication
(10) Pub. No.: US 2011/0079309 A1
(43) Pub. Date: Apr. 7, 2011

(54) Plumbers outer patch (pop)

(76) Inventors: Michael Thomas Esq., I, Taylor, MI (US); Judith Ann, Taylor, MI (US); Mandy Elias, Allen Park, MI (US)

(21) Appl. No.: 12/924,385

(22) Filed: Sep. 27, 2010

Related U.S. Application Data
(60) Provisional application No. 61/248,920, filed on Oct. 6, 2009.

(51) Int. Cl. F16L 55/16; B32B 37/12

(52) U.S. Cl. 138/98; 277/616; 156/60

(57) ABSTRACT

A patch that would bond to a surface as a retaining barrier having a preferred gum chemical adhesive bond coating continuous over the patch to prevent bond failure, water, fluid, material or air from venting into an aperture, surface, crack, protruding object and surface or area with a protective seal. A patch sleeve portion may be formed to fit around protruding object(s) independent of patch or attached to the patch portions that may be formed and fused together, each with or without an adhesive coating element applied during manufacturing or during application. The patch and sleeve portions may be formed separately and fused together in a press, injection mold, mold or formed to be independent. The process of injection molding, molding or other means can be used to form the patch and/or sleeve portions. Applying a layer or layers on both the patch, sleeve, seal or adhesive bonding element surfaces with a layer or layers continuous over the patch and adhesive to form a continuous coating for proper application during or after the production process. A Means known in the art, for example tacky adhesive sprays, tacky adhesive applications, rubber cement can also be employed to further ensure a firm seal or bond between the patch or adhesive coating and surface to be applied to. This can be applied during manufacturing or at the job site. A seal can be employed to prevent patch and adhesive from adhering to unwanted objects and removed prior to application. Methods of manufacturing and using the patch are also taught herein.

### BACKGROUND OF THE INVENTION

It is well known in the industry and the art that there is a need to form an effective and efficient means to prevent water, fluid or air leakage, primarily for Bathtub faucets, shower heads, sink faucets, surface openings with or without protruding objects, cracks and various areas to prevent water, liquid, material or air from venting, flowing or passing through area to keep area from venting or collecting water, fluid, air or any other matter. It is well known in the art, and various attempts have been made to introduce improved, efficient and effective means to prevent the above mentioned.

However, none of the prior art addresses a particularly acute problem in the field and that is of providing a strong and lasting seal between the surfaces aperture, crack or a protruding object (pipe, stem, rod, etc.).

The patch designs cover the surface area around an aperture, crack, and other areas being protected where the sleeve patch tightly grips the pipe, stem, or object(s) protruding through the surface with the patch portion covering the aperture and the surface area surrounding the aperture being protected.

The patch would eliminate time needed for caulk application and the curing of caulk, rubber components, cement, chemicals, foam or other methods used to cover a surface and fill the aperture, crack or gap between the pipe or object and the surface it protrudes through.

In many cases the caulk has curing times well over 24 hours or the caulk fails or does not entirely cure, forcing anyone to abandon the project during this period and wait until the caulk or filler dries. The caulk portion often seals the aperture; the caulk does not always cure or eventually decays, thus compromising the seal.

The wait time for the curing process prevents immediate usage of the tub, sink or other areas. The patch would allow use of any area the patch is applied to within minutes, making a dramatic improvement in the time of application while preventing valuable lost time.

At times the caulk or other compounds do not provide a strong seal around the aperture, for example: fully prevent water, fluid, material or air introduction which could result in further damage to the caulk or compound used to seal area, wall surface or other surfaces in need of protection during curing of sealant, especially if the caulk, element or compound (filler) is enclosed.

The enclosure of the applied compound could cause longer delays in curing or possibly keep the caulk or compound (otherwise referred to as filler) from curing or remain weak and unstable. Whereby the patch can accelerate usage for the area patch is being applied to within minutes of application of the patch while extending the life of the area being protected and offers a more rapid use of area and a more efficient and effective way to replace patch if any changes are made in area patch is being applied to.

It is common to find uncured or decayed caulk, decayed rubber, cement or other compounds (otherwise referred to as filler) lose their protective abilities days, weeks or months after application while the patch would offer a more stable solution to protect area patch is being applied to.

When a variety of fillers are placed over an aperture, around a protruding object or crack they could easily fail under normal, confined or enclosed conditions (between tub area and adjoining wall, sink, surface area, etc.) There are times when an installer will go so far as to place another filler over the existing damaged filler or replace the old filler with the same filler or a different type of filler and try to enable the product being applied to bond with the old product or remove the existing filler and fail to cover some openings surrounding the pipe, stems, cracks, aperture or protruding object at walls or surface to be secured but the solution has only limited effectiveness, as the filler does not provide reliable coverage that may prevent a breach, future damage, further failure and additional curing time.

Previous attempts to solve this problem include wrapping tape, use of plugs to fill gaps or holes, spray foam, caulk, cement and other costly and time consuming products but the opening eventually reveals itself, allowing water, liquid, material or air entry.

### FIELD OF THE INVENTION

The invention relates generally to a patch for stopping drainage, introduction or flow of water, fluid, material or air and specifically to various surfaces, protruding mechanisms and methods for covering areas in need of a protective application to cover a surface to prevent water, liquid, material or air from venting, flowing or passing through area that would prevent area from venting or collecting water, fluid, air or any other matter.

### DESCRIPTION OF RELATED ART

The patch is designed to eliminate the use of caulk, rubber, cement, other components or elements (otherwise referred to as filler) used around any aperture or crack, around a wall or other surface where needed for general application to a surface, where an aperture, crack, fixture, showerhead, stem, faucet, valve stem or any object protrudes from a surface yet strong enough to prevent water, liquid, material or air from venting, flowing or passing through area that would prevent area from venting or collecting water, fluid, air or any other matter.

The patch can be used to block water, fluid, matter or air from passing through an aperture, various surfaces, protruding objects or cracks to protect and to prevent water, liquid, material or air from venting, flowing or passing through area to be protected that would prevent area from venting or collecting water, fluid, air or any other matter.

Patches for pants, inner tubes, tires, eyes and other objects are historical in reference and do not address situations described within this application.

### BRIEF SUMMARY OF THE INVENTION

A solution is required that provides an adhesive bonding patch made of natural and/or synthetic, waterproof and/or water-resistant material that will ensure a strong, reliable seal and not break down under normal or exposed conditions and not simply the filling of the aperture, crack, surface area or surrounding protruding object(s) with a filler.

According to one aspect of the suggested invention that provides a patch layer or layers made of natural and/or synthetic, waterproof and/or water-resistant material with a preferred chemical gum adhesive bond layer or layers made of natural and/or synthetic, waterproof and/or water-resistant material for simple use to surround an intended area to prevent the introduction, venting or flow of air, fluid, matter or water for Bathtub faucets, shower heads, sink faucets, protruding objects or any surface aperture, cracks and various surfaces where the patch would prevent water, liquid, material or air from venting, flowing or passing through surface area protected compromising:

A patch member (1) having a layer or layers made of natural and/or synthetic, waterproof and/or water-resistant material with a generally flat exterior surface for placement against any surface area around an aperture, cracks, protruding objects and various surfaces where the patch would prevent water, liquid, material or air from venting, flowing or passing through area protected;

A bonding adhesive member (2) having a layer or layers made of natural and/or synthetic, waterproof and/or water-resistant preferred chemical gum adhesive bond coating or coatings applied to the patch member to form a single continuous coating(s) over the continuous flat patch member(s) (1) surface with the adhesive member uniting patch member(s) (1) and adhesive member(s) (2).

A seal member or members being a layer or layers of a protective synthetic and/or natural waterproof and/or water-resistant peal off seal member(s) (3) to protect patch member(s) (1) and adhesive bonding member(s) (2) from bonding with unintended objects until application.

The seal member(s) (3) having properties that would not permanently bond to the adhesive member(s) (2) over the continuous flat surface of adhesive member(s) (2) and act as a barrier to prevent unwanted bonding of the patch member(s) (1) and adhesive member(s) (2) to unintended objects, with the ability to peal off without damaging or removing part of the patch member(s) (1) or preferred chemical gum bonding adhesive member(s) (2).

The patch member(s) (1) and chemical gum adhesive bond member(s) (2) portions may be formed separately and attached with adhesive member(s) (2) applied to patch member (1) during installation and/or joined together during the manufacturing process. Means known in the art, for example rubber cement can also be applied to further ensure a firm seal between the patch member(s) (1) and preferred chemical gum-bonding adhesive member(s) (2) and surface the patch will be applied to or surround.

In preferred embodiments of the present invention (Drawing 1.2, FIGS. 1, 2, 3, 4 and 5), the patch member(s) (1) comprises a layer or layers of a water resistant and/or waterproof member made of synthetic and/or natural material, the adhesive member(s) (2) being a preferred chemical gum bonding adhesive member(s) (2) comprises of at least one preferred chemical gum adhesive bond coating layer made of waterproof and/or water-resistant synthetic and/or natural material or materials with a continuous coating over the continuous flat surface of the adjoining patch member(s) (1) and a third member being a seal member(s) (3) that comprises a protective removable water-resistant and/or waterproof synthetic and/or natural material as a protective cover for the adhesive bonding member (2) that can be removed prior to application.

According to another aspect of the present invention (Drawing 2.2, FIGS. 1, 2, 3, 4 and 5) there is provided a method of manufacturing the patch described above, comprising the steps of: forming the patch member(s) (1) as a layer or layers of water-resistant and/or waterproof, synthetic and/or natural material and applying preferably a water-resistant and/or water proof synthetic and/or natural chemical gum bond coating adhesive member(s) (2) to form a single continuous coating over the continuous flat surface of the patch member(s) (1) to join patch member(s) (1) with adhesive member(s) (2); placing the peal off seal member(s) (3) with preferably a water-resistant and/or water proof, synthetic and/or natural material adjoined to the adhesive member(s) (2) to prevent the patch member(s) (1) and adhesive member(s) (2) from adhering to unwanted objects to form a single continuous coating over the continuous surface of adjoining adhesive member(s) (2); additionally forming a sleeve member(s) (4) with preferably a water-resistant and/or water proof synthetic and/or natural material adjoined to the patch member(s) (1) in a press, injection mold or mold designed to adhere the patch member(s) (1) and sleeve member(s) (4) with alignment of apertures (5) in the patch member(s) (1) and sleeve member(s) (4), allowing protruding objects to be tightly surrounded by the sleeve member(s) (4); and subjecting the connected patch member(s) (1) and sleeve member(s) (4) to bond such that the patch member(s) (1) and sleeve member(s) (4) become as one with apertures (5) aligned with patch member(s) (1) and sleeve member(s) (4) or the sleeve member(s) (4) can be produced separately from the patch member(s) (1) having various sized apertures within sleeve member(s) being layer or layers of preferably water-resistant and/or water proof synthetic and/or natural material adjoined and/or placed independent of patch member(s) during application of invention to surface intended. Thus, in response to the problem at hand, the present invention provides a patch member(s) (1) with sleeve member(s) (4) that have a layer or layers over the continuous surface of adjoining adhesive member(s) (2) and seal member(s) (3) providing a strong and continuous bond to prevent seal failure and water, fluid, matter or air introduction.

The patch member(s) (1) and sleeve member(s) (4) portions may be formed separately or fused together in a press, injection mold, mold or any other means which bonds the patch member(s) (1) and sleeve member(s) (4) portions to unite with aperture(s) aligned and form a single unit continuous with an adhesive bond coating member(s) (2) over the continuous flat surface of adjoining patch member(s) (1). Means known in the art, for example rubber cement can also be employed to further ensure a firm seal between the patch and surface to be protected during production or at the site of installation with a protective seal(s) (4) to prevent union with unintended objects.

A detailed description of an exemplary embodiment of the present invention is given in the following, including methods of manufacture and use. It is to be understood, however, that the invention is not to be construed as limited to this embodiment.

### BRIEF DESCRIPTION SEVERAL VIEWS OF DRAWING 1.2

In the accompanying drawings, which illustrate an exemplary embodiment of the present invention:

FIG. 1 is an angled elevation sectional view of an exemplary embodiment of the patch of the present invention that illustrates members in assembled state; patch member(s) (1), adhesive bond member(s) (2), seal member(s) (3) of present invention.

FIG. 2 is an angled elevation view of an exemplary embodiment of the patch of the present invention which shows members in disassembled state; patch member(s) (1), adhesive bond member(s), (2) and seal member(s) (3) of present invention prior to assembly.

FIG. 3 is a side elevation sectional view of an exemplary embodiment of the patch of the present invention which illustrates members in an assembled state; patch member(s) (1), adhesive bond member(s), (2) seal member(s) (3) of present invention assembled.

FIG. 4 is a side elevation sectional view of an exemplary embodiment of the patch of the present invention which illustrates members in a disassembled state; patch member(s) (1), adhesive bond member (s) (2), seal member(s) (3) of present invention prior to assembly.

FIG. 5 is a front (mirrored) elevation sectional view of an exemplary embodiment of the patch of the present invention that shows members in a disassembled state; which shows the patch member(s) (1) adhesive bond member(s) (2) and seal member (s) (3) of present invention disassembled.

### BRIEF DESCRIPTION OF SEVERAL VIEWS OF DRAWING 2.2

In the accompanying drawings, which illustrate an exemplary embodiment of the present invention:

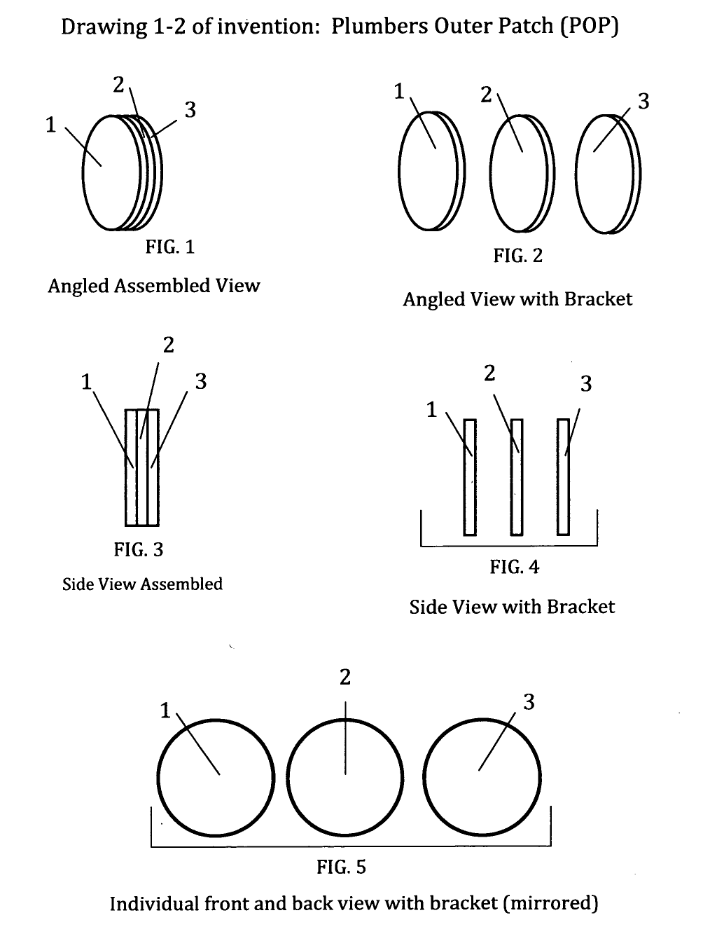

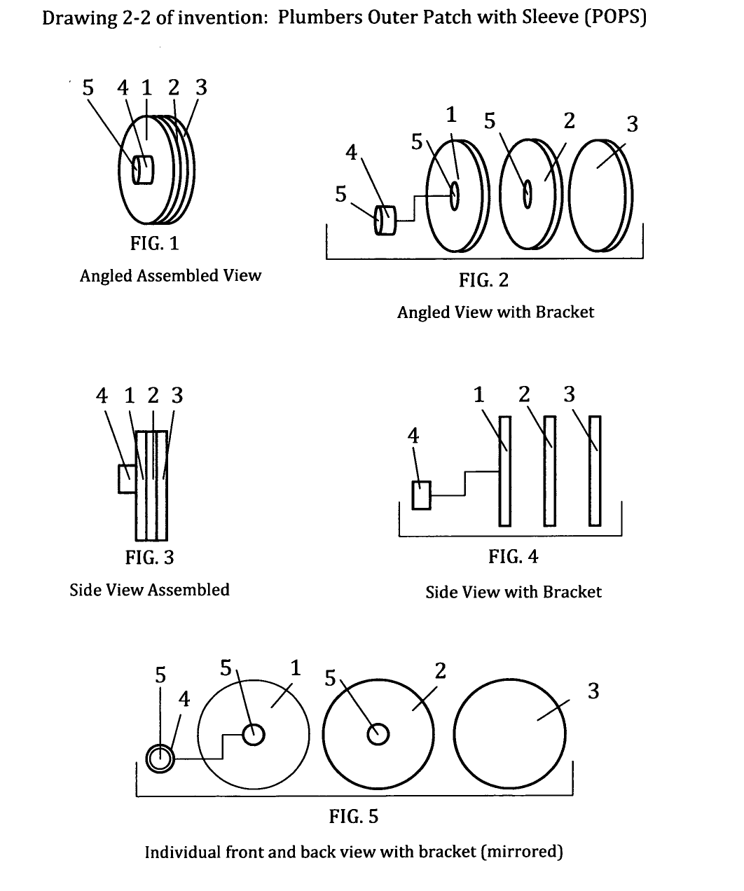

FIG. 1 is an angled elevation sectional view of an exemplary embodiment of the patch of the present invention that shows the followings members in assembled state; patch member(s) (1), adhesive bond member(s) (2), seal member(s) (3) and sleeve member(s) (4) with 5 being an aperture aligned with patch aperture (1), adhesive (2), seal (3) and sleeve aperture (4).

FIG. 2 is an angled elevation bracket view of an exemplary embodiment of the patch of the present invention which shows members in a disassembled state; patch member(s) (1), adhesive bond member(s) (2), seal member(s) (3), and sleeve member(s) (4), with aperture (5) aligned with patch aperture (1) and sleeve aperture (4), with adhesive bond (2) and seal (3) having optional aperture (5) that would be aligned with patch aperture (1) and sleeve aperture (4).

FIG. 3 is a side elevation sectional view of an exemplary embodiment of the patch of the present invention which shows members in assembled state; patch (1), adhesive bond member(s) (2), seal member(s) (3) and sleeve member(s) (4) illustrated as assembled members of present invention with apertures aligned.

FIG. 4 is a side elevation sectional bracket view of an exemplary embodiment of the patch of the present invention which illustrates members in a disassembled state; patch (1), adhesive bond (2), seal (3) and sleeve (4) member(s) of present invention with aperture (5) aligned with patch (1) and sleeve (4) members.

FIG. 5 is a front sectional view of an exemplary embodiment of the patch, which shows unassembled members; patch (1), adhesive (2), seal (3) and sleeve (4) members with 5 being an aperture.

### DETAILED DESCRIPTION OF THE INVENTION

A detailed description of an exemplary embodiment of the present invention is given in the following, including methods of manufacture and use. It is to be understood, however, that the invention is not to be construed as limited to this embodiment.

Referring now in detail to the accompanying drawing 1.2, there is illustrated an exemplary embodiment of a patch member generally illustrated in Drawing 1.2, FIGS. 1, 2, 3, 4 and 5.

The patch member(s) (1) comprises of a layer layers of water-resistant and/or water proof layer and/or layers of natural and/or synthetic material being the exterior surface and the adhesive member(s) (2) may be a layer and/or layers of a preferred gum chemical bonding adhesive coating(s) that may be applied during or after the production of the patch member(s) (1).

The adhesive member(s) (2) may be a layer or layers of synthetic and/or natural material, water-resistant and/or waterproof preferred chemical gum adhesive bond coating material being continuous across the generally flat surface of the patch member(s) (1). The adhesive member(s) (2) may be applied during or after production of members, providing protection of surface area without breaking down.

The seal member(s) (3) being a layer or layers of protective peal off seal (3) to prevent present invention from adhering to unwanted objects until ready for use, being continuous across the generally flat surface of the adhesive member(s) (2). The seal member(s) (3) may be made of synthetic and/or natural, waterproof and/or water resistant material, having properties that would not permanently bond to adhesive member(s) (2) continuous across the generally flat surface of the adhesive member(s) (2) and act as a barrier to prevent unwanted bonding of the patch member(s) (1) and adhesive member(s) (2) to objects with the seal member(s) (3) having the ability to peal off without damaging or removing part of the patch member(s) (1) and/or adhesive member(s) (2).

In preferred embodiments of the present invention; the patch member(s) (1) comprises a water resistant/water proof layer or layers of natural and/or synthetic material, an adhesive member(s) (2) having at least one preferred gum chemical bonding adhesive member(s) (2) made of a water-resistant and/or water proof layer or layers of natural and/or synthetic material coating being continuous across the generally flat surface of the patch member (1), a third layer having a protective removable seal member(s) (3) comprising of a water-resistant and/or water proof layer or layers of natural and/or synthetic material being continuous across the generally flat surface of the adhesive member(s) (2) preventing patch member(s) (1) and adhesive member(s) (2) from adhering to unwanted objects prior to installation.

According to another aspect of the present invention (claim 3), as set forth in claim 1, (Drawing 2.2, FIGS. 1, 2, 3, 4 and 5), there is provided a method of manufacturing the patch described above, comprising the steps of: a patch member(s) (1) having a generally flat surface as part of a layer or layers with the first layer or layers made of waterproof and/or water-resistant, natural and/or synthetic material designed with an aperture (5) fitted for the use intended, a preferred gum coated chemical adhesive bonding member(s) (2) comprising of a water-resistant and/or water proof layer or layers of natural and/or synthetic material applied to the patch member(s) (1) such that the coating(s) of the patch member(s) (1) bond together with the adhesive member(s) (2) with adhesive member(s) having a generally flat surface as part of a layer or layers with the first layer or layers comprising of a water-resistant and/or water proof layer or layers of natural and/or synthetic material having a preferred gum chemical bonding adhesive layer or layers to be placed over the patch member(s) (1) being continuous across the generally flat surface of the patch member(s) (1) as a coating to enable the patch invention to cover an area or surface in need of repair resulting in the adhesive coating(s) (2) being continuous across the generally flat surface of the patch member(s) (1), seal member(s) (3) having a generally flat surface as part of a layer or layers with the layer or layers made of waterproof and/or water-resistant, natural and/or synthetic material as a protective removable seal member(s) (3); covering the adhesive member(s) (2) being continuous across the generally flat surface of the patch member(s) to prevent the patch member(s) (1) and adhesive member(s) (2) from adhering to unintended objects, a sleeve member(s) (4) as part of a layer or layers made of waterproof and/or water-resistant, natural and/or synthetic material to act as a guard and tightly grip to the protruding object with an aperture (5) aligned with all apertures of this invention for the use intended.

According to another aspect of the present invention there is provided a method of using the patch described above, comprising the steps of: applying a preferred gum chemical bonding adhesive to the surface of the patch prior to application of patch or applying a preferred gum chemical bonding adhesive or other bonding agents to surface intended to be protected prior to application of patch or other adhesive applications, for example rubber cement can be added to further insure the integrity of adhesive bond.

Thus, in response to the problem at hand, the present invention provides a patch that has a coating(s) continuous over the patch member(s) (1), a preferred gum chemical bonding adhesive member(s) (2) providing a strong and continuous bond to prevent adhesive failure, water, fluid, material and air introduction. The patch member(s) (1) may be made of waterproof and/or water-resistant natural and/or synthetic material with attached preferred gum chemical bonding adhesive member(s) (2) providing a strong and continuous bond to patch member(s) (1) with at least one or more preferred gum chemical bonding adhesive layer(s) (2) that may be made of waterproof and/or water-resistant natural or synthetic material being continuous across the generally flat surface of the patch member(s) (1) applied during or after production to bond portions together to form a single, continuous coating with a peal off seal member(s) (3) made a layer or layers of waterproof and/or water-resistant natural and/or synthetic material covering the adhesive member(s) (2) continuous across the generally flat surface of the adhesive member(s) (2) to prevent patch member(s) (1) and adhesive member(s) (2) from adhering to unwanted areas. Means known in the art, for example rubber cement can also be employed to further ensure a firm bond between adhesive members and the intended surface the patch members would be applied to. With claims 1 & 2 the patch member (1) and adhesive member (2) portions may be formed separately.

With claim 3 the patch member(s) (1) and sleeve member(s) (4) made of a layer or layers of waterproof and/or water-resistant natural and/or synthetic material, acting as a protective shield to prevent protruding objects from water, fluid, material or air introduction which can be fused with patch member(s) (1) in a press, injection mold, mold or any other means which bonds the patch member(s) (1) and sleeve member(s) (4) portions together to form a single, continuous unit or the sleeve member(s) (4) can be manufactured independent of the patch with variable sized apertures and joined at the site of application to the patch member(s) (1) or the sleeve member(s) (4) can be made to stand alone, as a preference to installer. Means known in the art, for example rubber cement can also be employed to further ensure a firm seal between the patch and surface to be protected during production or at the site of installation on the surface the patch member(s) (1) is being installed.

What is claimed is:

1. A method of manufacturing a patch made of waterproof and/or water-resistant natural and/or synthetic material structured for use on a surface, as a barrier to prevent water, fluid, liquids, material or air from passing through an aperture of a surface, a protruding object or a protruding object or objects surrounded by a surface, aperture or crack comprising:
The patch Drawing 1.2, is comprised of: Patch member(s) (1) being made of a layer or layers of waterproof and/or water-resistant synthetic and/or natural material having a generally flat surface for placement against any surface area to prevent the flow or introduction of water, liquid, material or air from venting, flowing or passing through area to be protected.
Attached or applied to the patch would be a layer or layers of one or more of a preferred gum chemical bonding adhesive coating member(s) (2) made of waterproof and/or water-resistant natural and/or synthetic material with preferred gum chemical coating bonding adhesive being continuous across the generally flat surface of the patch member(s) (1) to adhere to any surface to prevent the flow or introduction of water, liquid, material or air from venting, flowing or passing through an aperture, object protruding from a surface, crack or any area in need of protection from the flow or introduction of water, liquid, material or air.
The seal member(s) (3) made of a layer or layers of waterproof and/or water-resistant natural and/or synthetic material being a third member acting as a protective cover preventing adhesive member(s) (2) from adhering to unwanted objects prior to use. The seal member (3) being made of waterproof and/or water-resistant natural and/or synthetic material that would enable seal member(s) (3) to be removed from the adhesive member(s) (2) without damage to the patch member(s) (1) or adhesive member(s) (2) enabling the seal member(s) (3) to be removed prior to use; wherein the patch member(s) (1) and the preferred gum chemical coated bonding adhesive member(s) (2) include a removable peal off seal member(s) (3) to prevent the patch member(s) (1) and adhesive member(s) (2) from adhering to unintended objects. The seal member(s) (3) made of a layer or layers of waterproof and/or water-resistant natural and/or synthetic material being continuous across the generally flat surface of the preferred gum chemical coating bonding adhesive member(s) (2); the method comprising the steps of: forming the patch member(s) (1) as a layer or stack of layers, the layers including at least one patch member(s) (1), at least one preferred gum chemical coating bonding adhesive member(s) (2) and one protective seal member(s) (3).
The design of the patch member(s) (1) should be made suitable for the type of application it is meant to service and to prevent the flow or introduction of water, liquid, material or air from venting, flowing or passing through area to be protected.
The preferred gum chemical coating bonding adhesive member(s) (2) made of waterproof and/or water-resistant natural and/or synthetic material, could contain one or more preferred gum chemical coating bonding adhesives or other types of adhesive(s) being continuous across the generally flat surface of the patch member(s) (1), including at least one preferred chemical gum coating bonding adhesive layer and should be sufficient enough to adhere to a surface and yet can be removable or bond permanently to any surface to prevent the flow or introduction of water, liquid, material or air from venting, flowing or passing through area to be protected.
The seal member(s) (3) being continuous across the generally flat surface of the adhesive member (2) with the seal member(s) (3) being made of waterproof and/or water-resistant natural and/or synthetic material that can be removed without damage to patch member(s) (1) or adhesive member(s) (2) to prevent patch member(s) (1) and/or adhesive member(s) (2) from damage prior to use and to prevent adhesive member(s) (2) from adhering to unintended objects.
The patch member(s) (1) could adhere to the area surrounding the surface of an aperture, crack, pipe, stem or other objects protruding from a tub, sink, wall or other surface or sub-surface areas using punch-out scored lines suitable for the job intended to prevent the flow or introduction of water, liquid, material or air from venting, flowing or passing through area to be protected.
The patch member(s) (1) and/or adhesive member(s) (2) design would eliminate the use of caulk, rubber, cement, chemicals (otherwise referred to as filler) used around any aperture at a wall or other surface where a crack, aperture, fixture, showerhead, stem, faucet, valve stem, or any objects that protrude through an aperture or surface to prevent water, liquid, material or air from venting, flowing or passing through area to prevent collection of water, fluid, air or any other matter.
The patch member(s) (1) can be used to surround objects (pipe, other material, cracks or aperture) located at any surface area where water, liquid or air should not travel or where water, liquid, material or air should be kept from entering. The patch member(s) (1) will provide a layer or layers made of waterproof and/or water-resistant natural and/or synthetic material being continuous across the generally flat surface of the patch member(s) (1) with a layer or layers of preferred chemical gum bond coating adhesive member side (2) made of waterproof and/or water-resistant natural and/or synthetic material being continuous across the generally flat surface of the patch member(s) (1) that would bond to any surface area water, liquid, material or air may travel or vent (e.g., wall, tub, horizontal or vertical surface, etc) to prevent the flow or introduction of water, liquid, material or air from venting, flowing or passing through area to be protected with a removable peal off seal member(s) (3) made of waterproof and/or water-resistant natural and/or synthetic material being continuous across the generally flat surface of the adhesive member(s) (2) to protect adhesive member(s) (2) from adhering to unwanted objects until seal member(s) (3) is removed from adhesive member(s) (2) prior to application, without damaging patch member(s) (1) or adhesive member(s) (2).
The thickness of the patch member(s) (1), adhesive member(s) (2) and seal member(s) (3) shall be enough to introduce a stable durable product to prevent water, liquid, material or air from flowing between the patch member(s) (1) adhesive member(s) (2) and surface area(s) being applied to.
The dimensions shall be large enough to cover an area surrounding an aperture, crack or protruding object and surface or surface area to prevent water, liquid, material or air from traveling through or between patch and area covered, to prevent the flow or introduction of water, liquid, material or air from venting, flowing or passing through area to be protected.
The design of the patch shall be a knockout, cutout, hole, slits, target pattern, slits in varying directions to cause it to be universal in application yet strong enough to prevent the flow or introduction of water, liquid, material or air from venting, flowing or passing through area to be protected.
Layer or layers of the patch member(s) (1) should be flexible and/or ridged enough to cover any surrounding surface area patch member(s) (1) would be applied to and have the ability to conform to bumps, bends, corners, irregular or flat surfaces, made of waterproof and/or water-resistant natural and/or synthetic material, being continuous across the generally flat surface of the patch area designed to cover an array of areas to prevent the flow or introduction of water, liquid, material or air from venting, flowing or passing through area to be protected.
The second part of the patch having at least one layer or layers made of waterproof and/or water-resistant natural and/or synthetic material with at least one preferred gum chemical bond coating adhesive member(s) (2) being continuous across the generally flat surface of the patch member(s) (1) providing a strong and continuous seal to prevent the flow or introduction of water, liquid, material or air from venting, flowing or passing through area to be protected.
Assembly of the patch member(s) (1) and adhesive member(s) (2) can be layered and performed during production, being continuous across the generally flat surface of both patch member(s) (1) and adhesive member(s) (2). The adhesive member(s) (2) could also be directly applied to the patch member(s) (1) being continuous across the generally flat surface of the patch member(s) (2) during manufacturing or by the end user, during installation, with an applicator or additional application of the preferred chemical bond coating adhesive(s) (2) placed by the manufacturer or applicant prior to or during the performance of installation of the patch on the surface of the patch member(s) (1) or surface patch member(s) (1) and/or adhesive member(s) (2) would be applied to.
The seal member(s) (3) being made of a layer or layers of waterproof and/or water-resistant natural and/or synthetic material being continuous across the generally flat surface of adhesive member(s) (2) being a removable peal off seal(s) (3) attached to the adhesive member(s) (2), to protect the integrity of the patch member(s) (1) and adhesive member(s) (2) to prevent the patch member(s) (1) and adhesive member(s) (2) from adhering to unwanted objects until seal member(s) (3) is removed for application to bond and unite patch member(s) (1) and/or adhesive member(s) (2) to intended surface area for continuous protection to prevent the flow or introduction of water, liquid, material or air from venting, flowing or passing through area to be protected.
Other means known in the art, for example: tacky spray, tacky chemical adhesive, permanent adhesive, rubber cement, or other bonding agents can be applied during or after the production process, rubber cement can also be employed to further ensure a firm seal or bond between the patch and surface or area to be covered or protected.
The methods according to claim 1 wherein the patch member(s) (1) made of waterproof and/or water-resistant natural and/or synthetic material and adhesive bond member(s) (2) made of waterproof and/or water-resistant natural and/or synthetic material are joined during manufacturing with adhesive member(s) being continuous across the generally flat surface of the patch member(s) (1) and adhesive member(s) (2) are added as a layer or additional layers during production or installation at the job site. Seal member(s) (3) made of waterproof and/or water-resistant natural and/or synthetic material are designed to be continuous across the generally flat surface of the adhesive member(s) (2) to protect patch member(s) (1) and adhesive member(s) (2) from bonding with other objects until installation to protect integrity of patch member(s) (1) and adhesive member(s) (2) from adhering to itself or unwanted objects prior to installation.

2. The method according to claim 1 (Drawing 1.2, FIGS. 1, 2 3, 4 and 5) wherein the patch would be universal in design, comprising of a layer and/or layers of water-resistant and/or water proof material with a layer or layers of natural and/or synthetic material comprising of a blank pad to accommodate other desired situations to cause it to be universal in application yet strong enough to prevent water, liquid, material or air from venting, flowing or passing through surface area being protected.

3. The method according to claim 1 (Drawing 2.2, FIGS. 1, 2, 3, 4 and 5) wherein the patch further comprises a sleeve member(s) (4) comprising of a layer or layers of water-resistant and/or water proof material with a layer or layers of natural and/or synthetic material(s) with aperture (5) positioned during or after the process of manufacturing to become as one with the patch member(s) (1) aperture (5) aligned with both the patch member(s) (1) and sleeve member(s) (4) apertures (5).
The sleeve member(s) (4) comprising of a layer or layers of water-resistant and/or water proof material with a layer or layers of natural and/or synthetic material(s) can be an independent part of the patch member(s), being manufactured as a separate unit of various sizes to accommodate the fitting of various sizes of protruding objects. The sleeve member(s) (4) could have a preferred gum chemical bonding adhesive comprising of a layer or layers of water-resistant and/or water proof material(s) with a layer or layers of natural and/or synthetic material(s) within the orifice lining and/or at the end of sleeve member(s) (4) with adhesive member(s) being applied during manufacturing or adhesive member(s) (2) can be applied to sleeve member(s) (5) during installation or bonding adhesive member(s) can be applied to the surface(s) sleeve member(s) (4) is being applied to. The sleeve member(s) (4) could stand alone and placed on a protruding object at the job site or joined to the patch member(s) (1) during production or installation.
Methods of manufacturing and using the patch can be dispatched through various changes coming within the spirit of the invention and may suggest themselves to those skilled in the art; hence, it is not intended to be limited to the specific embodiments shown and described or uses mentioned, but to be merely exemplary, the scope of my invention being limited only by the appended claims.
While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.
